(19) United States
(12) Patent Application Publication
(10) Pub. No.: US 2005/0015339 A1
(43) Pub. Date: Jan. 20, 2005

(54) Self-service equipment for banking

(75) Inventor: Adolfo Roberto Teixeira Gomes, Sao Paulo (BR)

Correspondence Address: STEINBERG & RASKIN, P.C., 1140 AVENUE OF THE AMERICAS, 15th FLOOR, NEW YORK, NY, 10036-5803, US

(73) Assignee: Itautec Philco S/A - Grupo Itautec Philco

(21) Appl. No.: 10/706,384

(22) Filed: Nov. 12, 2003

(30) Foreign Application Priority Data
Jul. 14, 2003 (BR) PI0302412-1

(51) Int. Cl. G06F 17/60

(52) U.S. Cl. 705/43

(57) ABSTRACT

Self-service banking machine including a main printer capable of receiving commands to print user-requested material, such as receipts, vouchers, statements and balances, and a spare printer having substantially the same capabilities as the main printer. The spare printer is automatically activated to print the user-requested material when the main printer is unable to print the user-requested material.

### FIELD OF THE INVENTION

The present invention relates to self-service machines and equipment for banking and other financial applications.

### BACKGROUND OF THE INVENTION

Automatic teller machines, commonly referred to as ATMs, are known and used to provide automation and decentralization of banking services in general. Such ATMs provide an interface for clients of the bank or other financial institution to request and obtain specific services, thereby enabling the client with the ability to interact with the bank or other financial institution directly through automated equipment and without involving a person.

These automatic teller machines are typically provided with a printer for printing user-requested material, such as but not limited to receipts, balance sheets, mini-statements and vouchers for deposits or payments, which are services directly requested by the user through a communication interface associated with the equipment.

A major inconvenience of this type of automatic teller machines is that many times, the printer is not available for use, whether due to lack of paper or due to breakdown or mechanical damage, or in some cases due to lack of communication with the communication interface accessed by the user. In these cases, the user is not able to receive a receipt for the operation carried out at the machine (payment of accounts, for instance) or the document requested (statement of banking operations, banking balance, etc.).

These occurrences often cause a great deal of dissatisfaction for the users and contribute to a reduction in the level of the user's expectations in the use of this type of equipment.

### OBJECTS AND SUMMARY OF THE INVENTION

It is an object of the present invention to provide a new and improved self-service machine and equipment for banking and other financial uses.

It is another object of the present invention to provide a new and improved self-service equipment for banking and other financial uses which provides an improved level of customer satisfaction.

In order to achieve these objects, and others, a self-service machine or equipment for banking and financial use in accordance with the invention includes two printers, a main printer and a spare printer, both having substantially the same technical characteristics, so that when the main printer is unavailable or inoperable for any reason whatsoever, the spare printer can be automatically activated from a stand-by mode to print receipts or documents requested by the user.

Activation of the spare printer is carried out on an exceptional basis, i.e., as an exception to the normal use of the equipment wherein a CPU or other processor includes a program which determines when an exceptional situation arises which necessitates activation of the spare printer, i.e., only when the main printer is not available. Simultaneous with the activation of the spare printer, the program preferably provides for communication of the unavailability of the main printer to a central monitoring facility, which then activates a maintenance service of the bank in charge of scheduling and providing immediate repair/feeding of the main printer. Once repaired or fed with paper as needed, the main printer resumes its functions, and the spare printer returns to a stand-by mode.

This invention will substantially eliminate the possibility of a user not receiving any receipts or requested documents for operations carried out at the automatic teller machines, thereby increasing the satisfaction of clients and consequently the client's reliability on this type of equipment.

A method for operating a self-service banking machine in accordance with the invention includes the steps of arranging a main printer in the machine capable of receiving commands to print user-requested material, arranging a spare printer having substantially the same capabilities as the main printer in the machine, determining if the main printer is unable to print user-requested material and activating the spare printer to print the user-requested material when the main printer is unable to print the user-requested material. In addition, it is possible to provide a user interface on the machine for receiving commands from a user causing printing of material related to a banking transaction being performed by the user at the machine and couple a processor embodying software to the user interface, to the main printer and to the spare printer. Commands are then directed from the processor to the main printer to print the material related to the banking transaction performed by the user at the machine and to activate the spare printer to print the material related to the banking transaction performed by the user at the machine when the main printer is unable to print the material. Preferably, a monitoring facility is notified when the main printer is unable to print the material, e.g., simultaneous with the activation of the spare printer.

### BRIEF DESCRIPTION OF THE DRAWING

A more complete appreciation of the present invention and many of the attendant advantages thereof will be readily understood by reference to the following detailed description when taken in conjunction with the accompanying drawing, wherein:

FIG. 1 is a flow chart of the operation of an automatic teller machine including two printers in accordance with the invention.

### DETAILED DESCRIPTION OF THE PREFERRED EMBODIMENTS

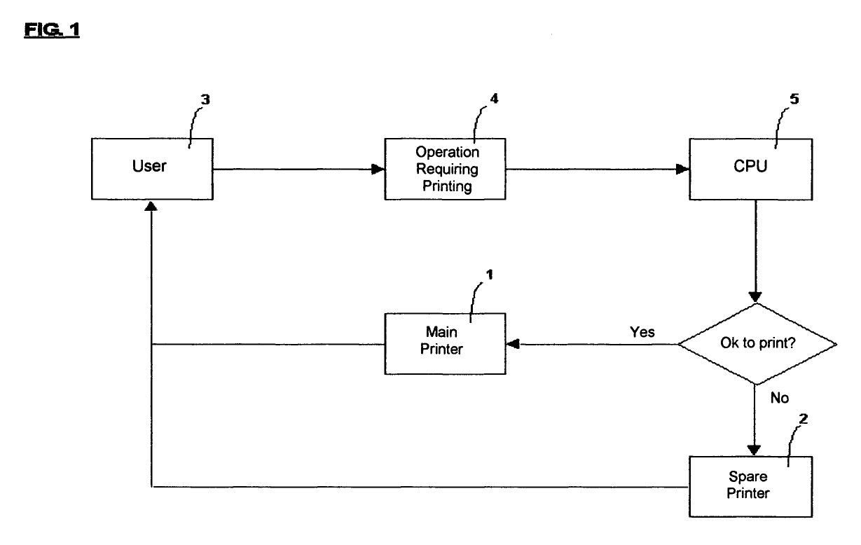

Referring to FIG. 1, a self-service equipment for banking in accordance with the invention includes a plurality of printers, i.e., at least a main printer 1 and a spare printer 2, both having the same or substantially the same technical characteristics. The spare printer 2 is provided for situations when the main printer 1 is unavailable for any reason whatsoever and the spare printer 2 is arranged to be automatically activated in these situations to print receipts or documents requested by the user.

As illustrated in the block diagram of FIG. 1, when a user 3 at the automatic teller machine requests execution of an operation that requires the printing of any receipt, voucher or other document 4, this request activates the program (software) of the CPU 5 of the machine. The CPU 5 communicates with the main printer 1 to direct the printing of a receipt of payment, a statement or balance and delivering thereof to the user. When the main printer 1 is unavailable, for example, due to lack of paper, breakdown, or lack of communication with the CPU 5, the software of the CPU 5 is programmed to indicate an exception to the usual communication with the main printer 1 and activate the spare printer 2 from a stand-by mode to print the receipt/voucher/document desired by the user.

Activation of the spare printer 2 is carried out on an exceptional basis, i.e., the printer 2 is activated only when the main printer 1 is not available. Ideally, when such an exceptional case exists, simultaneous with the activation of the spare printer 2, the program initiates communication of the unavailability of the main printer to a central monitoring facility which will then activate a maintenance service of the bank in charge of repairing or the main printer 1 and feeding paper into the main printer 1 as needed. Once the main printer 1 is repaired or provided with a supply of paper, the main printer 1 resumes its functions, and the spare printer 2 returns to a stand-by mode.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. A self-service banking machine, comprising:
a main printer capable of receiving commands to print user-requested material; and
a spare printer having substantially the same capabilities as said main printer and being activated to print the user-requested material when said main printer is unable to print the user-requested material.

2. The self-service banking machine of claim 1, further comprising:
a user interface for receiving commands from a user causing printing of material related to a banking transaction being performed by the user at the machine; and
a processor embodying software coupled to said user interface for generating commands to said main printer and to said spare printer to print the material related to the banking transaction performed by the user at the machine and for activating said spare printer,
said main printer and said spare printer being coupled to said processor and receiving the commands to print material from said processor.

3. The self-service banking machine of claim 2, wherein said processor is arranged to initiate a communication of the inability of said main printer to print the user-requested material to a monitoring facility simultaneous with the activation of said spare printer to print the user-requested material.

4. The self-service banking machine of claim 2, wherein said spare printer is activated by said processor only when said main printer is unable to print the user-requested material.

5. A self-service banking machine, comprising:
a user interface for receiving commands from a user causing printing of material related to a banking transaction being performed by the user at the machine;
a processor embodying software coupled to said user interface for generating commands to print the material related to the banking transaction performed by the user;
a main printer coupled to said processor and receiving commands to print material from said processor; and
a spare printer coupled to said processor and having substantially the same capabilities as said main printer, said processor being arranged to activate said spare printer to print the user-requested material when said main printer is unable to print the user-requested material.

6. The self-service banking machine of claim 5, wherein said processor is arranged to initiate a communication of the inability of said main printer to print the user-requested material to a monitoring facility simultaneous with the activation of said spare printer to print the user-requested material.

7. The self-service machine of claim 5, wherein said processor is arranged to activate said spare printer to print the user-requested material when said main printer is unable to print the user-requested material.

8. A method for operating a self-service banking machine, comprising the steps of:
arranging a main printer in the machine capable of receiving commands to print user-requested material;
arranging a spare printer having substantially the same capabilities as the main printer in the machine;
determining if the main printer is unable to print user-requested material; and
activating the spare printer to print the user-requested material when the main printer is unable to print the user-requested material.

9. The method of claim 8, further comprising the steps of:
providing a user interface on the machine for receiving commands from a user causing printing of material related to a banking transaction being performed by the user at the machine; and
coupling a processor embodying software to the user interface, to the main printer and to the spare printer;
directing commands from the processor to the main printer to print the material related to the banking transaction performed by the user at the machine and to activate the spare printer to print the material related to the banking transaction performed by the user at the machine when the main printer is unable to print the material.

10. The method of claim 8, further comprising the step of notifying a monitoring facility when the main printer is unable to print the material.

11. The method of claim 10, wherein the monitoring facility is notified simultaneous with the activation of the spare printer.
